(19) United States
(12) Patent Application Publication
(10) Pub. No.: US 2023/0238901 A1
(43) Pub. Date: Jul. 27, 2023

(54) Mechanical Energy Storage Unit-based Energy Platform

(71) Applicant: Torus Inc., Sandy, UT (US)

(72) Inventors: Nathan Walkingshaw, Sandy, UT (US); Gilbert Lee, Sandy, UT (US)

(21) Appl. No.: 18/160,887

(22) Filed: Jan. 27, 2023

Related U.S. Application Data
(60) Provisional application No. 63/303,984, filed on Jan. 27, 2022.

(51) Int. Cl. H02K 7/02

(52) U.S. Cl. CPC H02K 7/025

(57) ABSTRACT

A system may include a first node having a first mechanical energy storage unit (MESU) located in a first geographical location, the first node being coupled for communication with an energy as a service (EaaS) platform. A system may include a second node having a second MESU located in a second geographical location that is distinct from the first geographical location, the second node being coupled for communication with the EaaS platform, wherein the first MESU of the first node and the second MESU of the second node are each configured to send a power banking status to the EaaS platform and to extract or bank power based on signals received from the EaaS platform.

### BACKGROUND

The conventional power grid, which is an interconnected network for electricity delivery from power producers to consumers, has numerous disadvantages that have made it nearly impossible for producers to meet surging demand while also addressing modern day issues such as climate change, natural disasters, transition to green energy, and energy affordability.

By way of example, existing transmission infrastructure is aging and expensive to maintain; is susceptible to intrusion by hackers and other nefarious actors; is susceptible to brownouts and blackouts, especially with rising world temperatures due to climate change; increasingly has been found to malfunction due to such rising temperatures, causing disastrous wildfires; breaks down during major natural disasters such as hurricanes, leaving large populations without power during their very hour of need; and is inefficient, resulting in energy loss and heat.

Moreover, existing power infrastructure is largely unable to store energy when consumer demand is low for use later when demand for energy surges. Rather, power is generally generated and provided just-in-time to consumers, and any excess energy is typically dumped to ground and wasted.

Despite heavy investment and the promotion of green alternatives, currently only about a third of global electricity comes from renewable sources. This is in part due to producers having already investment significantly in the existing carbon-based infrastructure and having little incentive to change given their market dominance (often energy producers are the only provider available in a given locale). It is also due to the existing infrastructure not being designed for power generation by alternative sources, such as residential power generation using solar or wind technologies. In fact, many producers continue to lobby US state governments to rollback solar net metering policies because of the impact residential solar power has had on revenue and infrastructure, thus further frustrating the transition to renewable sources of energy.

It is clear that a new energy platform that provides for a rapid transition to renewable energy sources, affordable large-scale power banking and elective consumer control and independence is needed.

### SUMMARY

In some aspects, the techniques described herein relate to a system including: a first node having a first mechanical energy storage unit (MESU) located in a first geographical location, the first node being coupled for communication with an energy as a service (EaaS) platform; and a second node having a second MESU located in a second geographical location that is distinct from the first geographical location, the second node being coupled for communication with the EaaS platform, wherein the first MESU of the first node and the second MESU of the second node are each configured to send a power banking status to the EaaS platform and to extract or bank power based on signals received from the EaaS platform.

In some aspects, the techniques described herein relate to a system, wherein each of the first MESU and the second MESU include a motor coupled to one or more flywheels that is capable of increasing or decreasing a spin-rate of the one or more flywheels to add to or extract power from the one or more flywheels, respectively.

In some aspects, the techniques described herein relate to a system, wherein each of the first MESU and the second MESU are capable of storing between 3 kWh and 100 kWh of power.

In some aspects, the techniques described herein relate to a system, further including: the Energy as a Service (EaaS) platform including: a power management application coupled to the first MESU of the first node and the second MESU of the second node via a communications network; and one or more node application programming interfaces (APIs) coupled to the power management application and configured to receive the power banking status and provide the power banking status to the power management application; and one or more utility APIs coupled to the power management application and configured to receive one or more energy requests via a communications network from a utility server.

In some aspects, the techniques described herein relate to a system, wherein the one or more utility APIs are further configured to receive a signal notifying the EaaS platform of an energy surplus or an energy demand.

In some aspects, the techniques described herein relate to a system, wherein each of the first node and the second node includes an EaaS interface configured to receive a signal instructing a spin-up or a spin-down of the first MESU or the second MESU.

In some aspects, the techniques described herein relate to a system, wherein: the power management application is configured to: receive a user setting specifying a spin rate for the first MESU; store the user setting in a data store; and transmit the user setting to the first node; and the first MESU is configured to limit the spin rate for the first MESU based on the user setting.

In some aspects, the techniques described herein relate to a system, wherein: the power management application is configured to: receive a user-specified power banking parameter for the first MESU; store the user-specified power banking parameter in a data store in association with the first MESU; and transmit a user-specified power banking parameter to the first node; and the first MESU is configured to enable or disable the first MESU based on the user-specified power banking parameter.

In some aspects, the techniques described herein relate to a system, wherein: each of the first node and the second node includes an energy manager configured to interact with an independent power system that provides off-grid power to one or more of the first node and the second node; and each of the first MESU of the first node and the second MESU of the second node each includes MESU hardware electrically coupled to the independent power system, respectively.

In some aspects, the techniques described herein relate to a system, the energy manager selectively determines whether to use power from the independent power system or a power grid based on one or more of a power capacity of the independent power system and a power capacity of the power grid.

In some aspects, the techniques described herein relate to a computer-implemented method including: receiving, by one or more processors, a signal instructing a spin up of one or more mechanical energy storage units (MESU), each of the one or more MESUs including a mechanism for mechanically storing energy; receiving, by the one or more processors, a power banking parameter for the one or more MESUs; and enabling the one or more MESUs to receive power based on the power banking parameter and the signal instructing the spin up of the one or more MESUs.

In some aspects, the techniques described herein relate to a computer-implemented method, wherein each of the one or more MESUs include a motor coupled to one or more flywheels that is capable of increasing or decreasing a spin-rate of the one or more flywheels to add to or extract power from the one or more flywheels, respectively.

In some aspects, the techniques described herein relate to a computer-implemented method, further including generating, by the one or more processors, a signal instructing the spin up or a spin down of the one or more MESUs based on a determined energy surplus or demand.

In some aspects, the techniques described herein relate to a computer-implemented method, further including: receiving, by the one or more processors, a user setting specifying a spin rate for the one or more MESUs; storing, by the one or more processors, the user setting in a data store; and configuring, by the one or more processors, the one or more MESUs to limit the spin rate based on the user setting in the data store.

In some aspects, the techniques described herein relate to a computer-implemented method, wherein: the one or more MESUs are coupled with one or more nodes, the one or more nodes including an energy manager configured to interact with an independent power system that provides off-grid power to the one or more MESUs; and each of the one or more MESUs includes hardware electrically coupled to the independent power system.

In some aspects, the techniques described herein relate to a computer-implemented method, further including: determining, the one or more processors, to use power from the independent power system based on a power capacity of the independent power system; and configuring, by the one or more processors, the one or more nodes to use power from the independent power system to spin up the one or more MESUs.

In some aspects, the techniques described herein relate to a computer-implemented method, further including: determining to use power from a power grid based on one or more of a power capacity of the independent power system and a power capacity of the power grid; and configuring, by the one or more processors, the one or more nodes to use power from the power grid to spin up the one or more MESUs.

In some aspects, the techniques described herein relate to a computer-implemented method, further including: receiving, by the one or more processors, a signal instructing a spin-down of the one or more MESUs; and instructing the one or more MESUs to spin down based on the power banking parameter and the signal instructing the spin down.

In some aspects, the techniques described herein relate to a computer-implemented method, wherein: the one or more MESUs receive electrical current responsive to the instruction to spin up; and the one or more MESUs output electrical current responsive to the instruction to spin down.

In some aspects, the techniques described herein relate to a computer-implemented method, wherein the signal instructing the spin up or the signal instructing the spin down of the one or more MESUs is based on one or more energy requests received via a communications network from a utility server.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 depicts a block diagram representing an example energy as a service platform.

FIG. 2 depicts a block diagram showing example components of, and the interaction between, the utility server, the node(s), and the EaaS manager.

FIGS. 3A-3C depict a signal diagram illustrating an example method for banking and extracting energy for a utility to satisfy a power need.

FIG. 4 is a flowchart illustrating an example method for peer-to-peer power sharing.

FIG. 5A is a flowchart illustrating an example method for providing a cyclical storage and release solution based on power demand, production, and/or other factors.

FIG. 5B depicts a graph illustrating an example power cycle for a given day of the week for a premises or a power grid.

FIGS. 6A - 6C depict example user interfaces for configuring the MESU(s) associated with a node and/or storage cluster.

FIGS. 7A-7C depict example user interfaces indicating available power and other information regarding MESU(s).

### DESCRIPTION

The innovative energy technology disclosed in this document provides novel advantages including the ability to integrate modern technology with conventional power infrastructure; enable rapid transition to renewable energy sources; use the power grid 130 as a backup; store power locally in nodes and regionalized storage clusters 160 of node(s) 140; isolate and minimize the impact of power outages; whether caused by natural disasters, infrastructure failure, or other factors; provide affordable alternatives to expensive and environmentally unfriendly electrochemical batteries; provide consumers the option to be independent from carbon-based power sources; and decentralize electric power production.

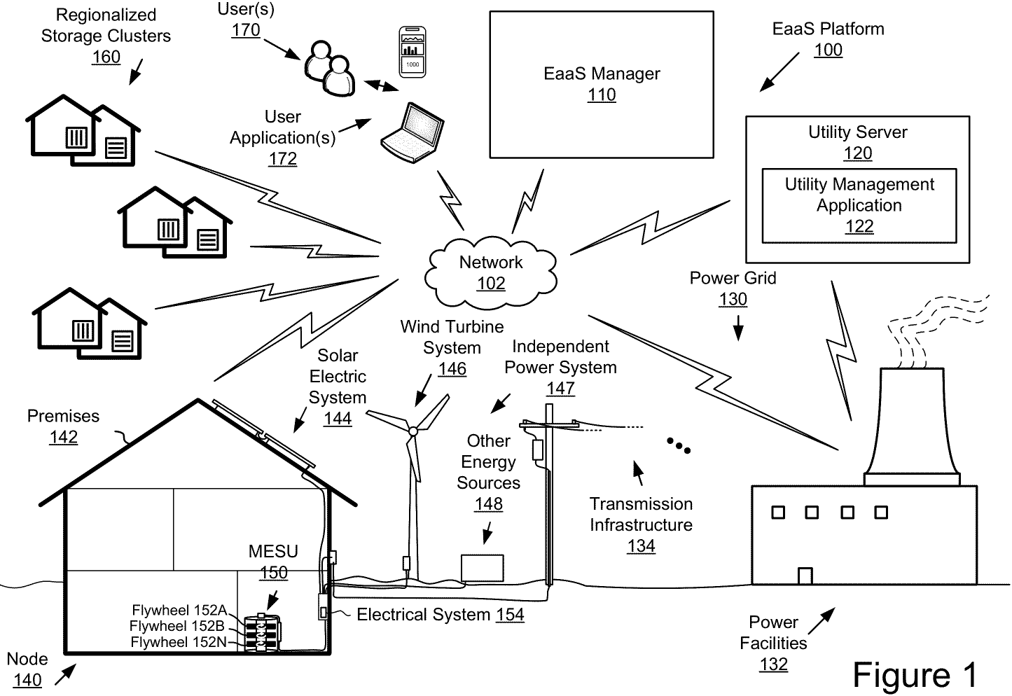

As depicted in FIG. 1, the innovative energy technology described herein may comprise an energy as a service platform (EaaS platform) 100. The EaaS platform 100 may include an EaaS manager 110, user application(s) 172 operable on computing devices accessible to and interactable by User(s) 170 of the EaaS platform 100 and configured to send or receive data to the EaaS manager 110, regionalized storage clusters 160 comprised of one or more nodes 140, and the power grid 130 that comprises one or more Power Facilities 132 that are connected to a Power transmission infrastructure 134.

A node 140 is comprised of a power consuming entity and at least one MESU 150. A node 140 may be an entity that either consumers power itself or is coupled to entities that consumer power. In FIG. 1, a node 140 is depicted as a Premises 142, such as a residential home, but it should be understood that any entity that consumes power is applicable, such as one or more appliances, a commercial structure such as a warehouse or office building, an electronic device or system (whether configured to move or static), a transportation system and/or vehicle, a transportation charging system, a power supply, a power substation, a power substation backup, etc. A regionalized storage cluster includes two or more nodes 140 in a given geographical region. A storage cluster may provide power banking functionality, as discussed further herein. The elements of the node 140 including the MESU(s) 150, the Independent Power System 147, the power grid 130, and/or any appliances and/or other entities, may be electrically coupled via an Electrical System 154 including wiring, junctions, switches, plugs, breakers, transformers, inverters, controllers, and any other suitable electrical componentry.

In the depicted example, the node 140 is equipped with or coupled to power generating technology, such as an independent power system 147 and/or the power grid 130. The independent power system 147 may comprise power generating technology that is localized and that allows for independent power generation, such as renewable power generating technology. Non-limiting examples include a solar electric system 144 (comprising a solar array, controllers, inverters, etc.), a wind turbine system 146 (comprising turbine(s), controllers, inverters, etc.), and/or Other Energy Sources 148, such as hydropower, geothermal, nuclear, systems and their constituent components, etc. The power generating technology may additionally or alternatively be conventional carbon-based power generating technology such as the depicted power grid 130, although for carbon negative or neutral implementation, a greener power generating technology may be preferred.

The node 140 includes or is coupled to an energy storage unit that is capable of storing any excess power that is produced by the power generating technology. In some embodiments, the energy storage unit may comprise a Mechanical Energy Storage Unit (MESU) 150. The MESU 150 includes one or more flywheels 152A, 152B .... 152N (also simply referred to individually or collectively as 152). The MESU’s 150 convert the electricity received from the power generating technology to kinetic energy by spinning up (increasing the spin rate) of the flywheels 152.

Each flywheel 152 may be configured to store up to a certain maximum about of energy. By way of non-limiting example, a motor coupled to the flywheel 152 may be configured to spin the flywheel 152 up to between 15,000 rotations per minute (RPM) and 25,000 RPM, such that the flywheel 152 may store between 18 kilowatt hours (kWh) and 28 kWh of electricity. Combined, three stacked flywheels 152 could store between 54 kWh and 84 kWh of power. During hours in which the power generation technology, such as the solar cells, produce less power than what is consumed by the electrical apparatuses (e.g., appliances) of the Premises 142, the motor may be operated as a generator that converts the kinetic (mechanical) energy stored in the flywheel 152 to electricity, thereby pulling power from the flywheel 152 to meet the local power needs of the node 140 (e.g., power the electrical apparatuses of the Premises 142). In this example, advantageously the node 140 may use an average of 15 kWh of power daily and the MESU 150 is capable of powering the node 140 fully for about 4-6 days should the local power generating cease to produce any power.

In another example, as discussed further elsewhere herein, a utility may have integrated with the EaaS manager 110 and its utility management application 122 signal the power management application 111 via the storage cluster APIs 112 that it is experiencing a surge in demand for power, and the power management application 111 may signal a node 140 or cluster of nodes 140 (e.g., storage cluster 160) to spin off power from the flywheels 152 and provide the energy back to the grid through the transmission infrastructure 134, which may be connected to the node(s) 140 through connection points (e.g., two or three phase electrical service drops or buried power lines connected to a service panel, which typically includes power meter(s)). Reversely, the utility may be producing excess power and may wish to bank/store the power. The utility management application 122 may signal the power management application 111 via the storage cluster APIs 112 that it needs to store a given amount of power, and the power management application 111 may in turn signal a node 140 or cluster(s) of node(s) 140, such as one or more regionalized storage clusters 160 to inform them of the storage need, and node(s) 140 in those storage cluster(s)160 that have excess capacity and are configured to receive power from the grid may receive the power through the transmission infrastructure 134 and store it as mechanical energy in the MESUs for later retrieval. The EaaS platform 100 may charge the utility for the power banking service, as discussed further elsewhere herein.

It should be understood that the RPMs and kWh figures provided in the prior paragraph are meant as non-limiting examples and that the MESU’s 150 may be configured with flywheels 152 that are capable of storing more or less power depending on the implementation. For example, the weight of the flywheels 152, the materials used for the flywheels 152, the size and configuration of the flywheels 152, the efficiency of the motor and bearings, and so forth, may all be adjusted based on the use case to provide a desired about of back-up power for the node 140. By way of further example, a flywheel 152 may be made of steel, aluminum, carbon fiber, titanium, any suitable alloy, and/or any other material that is capable of handling the cycles, vibration, radial and sheer stress and strain, and other conditions to which such a flywheel 152 would be subjected.

The power transmission infrastructure 134 comprises a power network that couples power-consuming entities, such as homes, offices, appliances, etc., to power facilities that generate power from carbon, nuclear, and/or natural sources. The transmission infrastructure 134 may include intervening elements, such as step-up transformers, substations, transmission lines, and so forth, which are interconnected to provide power widely to different geographical regions.

A power utility 301 (also simply referred to as a utility 301), which may own and operate one or more power facilities and portions of the transmission infrastructure 134, may operate a utility server configured to execute a utility management application 122. The utility management application 122 may perform various functions such as load balancing, load managing, and grid energy storage, to manage the supply of electricity based on real-time demand. However, given the limitations of existing grid technologies, power outages, brownouts, and expensive peak power costs are still the norm.

A user may use an instance of a User Application 172 executing on a computing device, such as the user’s mobile phone or personal computer, to configure and interact with the MESU(s) 150 that they are authorized to control, such as a MESU 150 installed at their home or business, as discussed further elsewhere herein.

As shown in FIG. 1, the EaaS manager 110, the utility server 120, the Power Facilities 132, elements of the power grid 130, the wind turbine system 146, the solar electric system 144, the Other Sources 148, the node(s) 140, the regionalized storage clusters 160, the user applications 172 and associated computing devices, etc., may be coupled for communication and connected to the network 102 via wireless or wired connections (using network interfaces associated with the computing devices of the foregoing elements). The network 102 may include any number of networks and/or network types. For example, the network 102 may include one or more local area networks (LANs), wide area networks (WANs) (e.g., the Internet), virtual private networks (VPNs), wireless wide area network (WWANs), WiMAX° networks, personal area networks (PANs) (e.g., Bluetooth° communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The EaaS manager 110, the utility server 120, the node(s) 140, the power facilities, and the user devices may have computer processors, memory, and other elements providing them with non-transitory data processing, storing, and communication capabilities. For example, each of the foregoing elements may include one or more hardware servers, server arrays, storage devices, network interfaces, and/or other computing elements, etc. In some implementations, one or more of the foregoing elements may include one or more virtual servers, which operate in a host server environment. Other variations are also possible and contemplated.

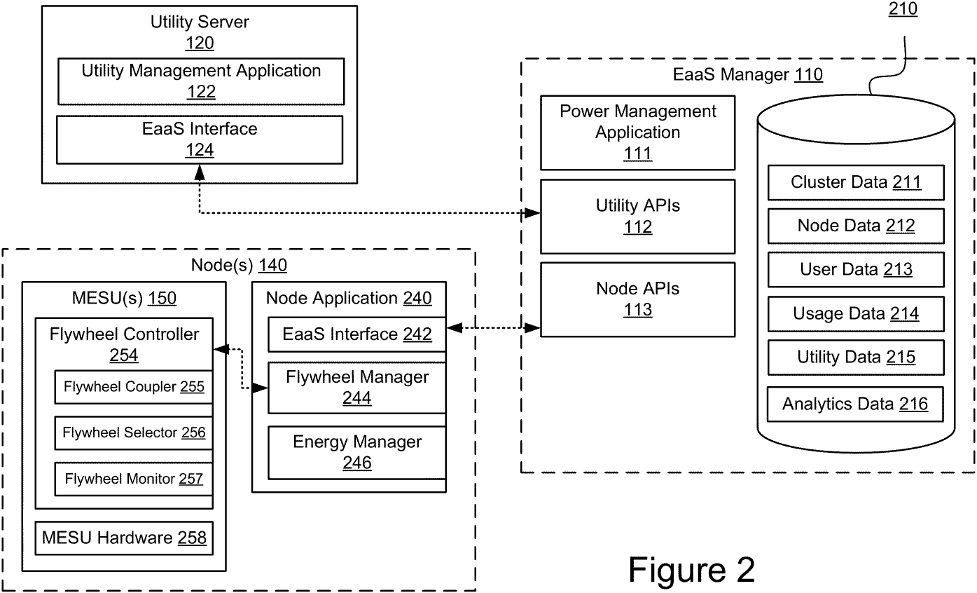

It should be understood that the EaaS platform 100 illustrated in FIG. 1 and the diagram illustrated in FIG. 2 are representative of example systems and that a variety of different system environments and configurations are contemplated and are within the scope of the present disclosure. For example, various acts and/or functionality may be moved between entities (e.g., from a server to a client, or vice versa, between servers, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc., without departing from the scope of this disclosure.

FIG. 2 depicts a block diagram showing example components of, and the interaction between, the utility server 120, the node(s) 140, and the EaaS manager 110. The utility server includes an instance of the utility management application 122 and an EaaS interface 124. The EaaS manager 110 includes a power management application 111, Utility APIs 112, node APIs 113, MESU APIs 114, and a data store 210. The data store 210 may store and provide access to data related to the EaaS platform 100, such as cluster data 211, node data 212, user data 213, usage data 214, utility data 214, and analytics data 216.

A node 140 of the EaaS platform may include one or more MESU(s) 150. A MESU 150 may include an instance of a flywheel controller 254. The flywheel controller 254 may include a flywheel coupler 255, a flywheel selector 256, and flywheel monitor 257. The MESU hardware 258 may comprise a chassis, one or more flywheels 152, magnets and/or bearings, a flywheel coupler 255, and/or a motor-generator. The motor-generator may be coupled to each flywheel 152 via a flywheel coupler 255. The flywheel coupler 255 may engage and disengage the motor-generator from the flywheel 152, such that each flywheel 152 may spin freely when disengaged and may be coupled to the motor-generator when engaged such that the motor-generator may increase the speed of the flywheel 152 (spin up the flywheel 152), or the flywheel 152 may spin the generator to produce power. Each flywheel 152 may be levitated using magnets to minimize the friction caused by the rotation of flywheel 152. As an example, a maglev unit may be used to suspend and retain the flywheel 152 while spinning.

Additionally or alternatively, bearings, such as but not limited to ceramic bearings, may be used to support and retain the flywheel 152 while spinning. The chassis may house and support the flywheels 152. flywheels 152 may be arranged horizontally or vertically. In horizontal orientation, flywheels 152 may have a wheel-like shape and may be stackable one on another in the same chassis, but still configured to spin independently of one another. In such a configuration, the coupler couple to each flywheel 152 independently, or more than one coupler and motor may be used, depending on the implementation. In a vertical orientation, the flywheels 152 may have a roll like shape, and may be positioned parallel to one another in the chassis. In either orientation, in some embodiments, the chassis may include a housing that encloses the MESU 150 and provides a vacuum environment in which the components of the MESU 150 may operate. This is advantageous as it may seal out dirt, debris, and corrosion causing elements, and allow for the flywheels 152 and other components to optimally operate.

In some embodiments, a node 140 may include one or more MESU(s) 150 and may act as a manager of the MESU(s), may receive and process information from the EaaS manager 110 for the two or more MESU(s) 150, and may send signals to the MESU(s) 150 (e.g., via the flywheel controller 254 and/or MESU hardware 258) and receive and process signals from the MESU(s) 150 (e.g., via the flywheel controller 254 and/or MESU hardware 258), to control the functionality and operations of the MESU(s). In some further embodiments, the structure, acts, and/or functionality of the flywheel controller 254 and the node application 240 and their constituent components may be combined, and the node 140 may represent a MESU(s) 150 itself, to which one or more appliances that consume power may be coupled to receive power. Other variations are also possible and contemplated.

The utility management application 122, the flywheel controller 254, the node application, the node management application, the utility APIs, the node APIs, and the MESU APIs may each include hardware and/or software executable to provide the acts and functionality disclosed herein.

Specifically, the utility management application 122 may be executable by the utility server to monitor power generation and distribution by one or more power facilities and a transmission infrastructure 134. The utility management application 122 may receive signals from various entities of the EaaS platform, such as the EaaS manager 110, the nodes, the transmission infrastructure 134, other utility management applications associated with other providers, and so forth. The utility management application 122 may communicate via the EaaS interface 124 with the EaaS manager 110 to access the services provided by the EaaS manager 110. In particular, the EaaS interface 124 may interact with the utility APIs of the EaaS manager 110 to request power banking, request the provision of supplemental power, to provide usage, performance, and/or demand data, and so forth. In some embodiments, the EaaS interface 124 may generate and transmit a secure request via the network to the utility APIs. The power management application 111 may receive the request via the utility APIs and process it accordingly.

The power management application 111 may be coupled to the data store 210 to store and retrieve data. The data stored by the data store 210 may be organized and queried using any type of data stored in the data store (e.g., cluster ID, user ID, utility ID, node ID, MESU ID, configuration data, etc.). The data store 210 may include file systems, databases, data tables, documents, or other organized collections of data.

Cluster data 211 may comprise information about a cluster of two or more nodes (e.g., regionalized storage cluster), such as the identity of the node(s) 140, the storage capacity of the storage cluster 160, the availability of the storage cluster 160, the operational health of the storage cluster 160 and/or constituent MESU(s) 150, the historical performance of the storage cluster 160, etc.).

Node data 212 may comprise information about a node, such as the number of MESUs installed at the node 140, the type of node 140, the operational health of the MESU(s) 150, any restrictions or operation parameters of the MESU(s) 150, configuration data for the MESU(s) 150, identifiers of the MESU(s) 150, who the MESU(s) 150 belong to, whether the MESU(s) 150 can be used for banking grid power, whether the MESU(s) 150 have been inactivated, and so forth.

User data 213 may comprise information about the user associated with a storage cluster 160, node 140 or MESU 150, including user account information, login information, user preferences governing the MESUs (e.g., schedule data, activation/inactivation data, etc.).

Usage data 214 may comprise information about the usage of the clusters and/or MESU(s) 150, such as spin rates of the flywheels 152, power output levels, maintenance periods, downtime, inactive periods, third-party use (e.g., use by utilities or neighboring nodes 140), etc.

Utility data 215 may comprise information about utilities that have partnered with the EaaS platform 100, such as utility account information, utility capability information, power banking requirements, contractual parameters, performance requirements, power grid 130 specifications, etc.

Analytics data 216 may comprise insights about the EaaS platform 100, such as local vs. grid power generation, aggregate usage data, aggregate performance data, etc. It should be understood that any other data that would be suitable and applicable to the EaaS platform 100 may be stored and processed by the EaaS manager 110.

The node application 240 and the flywheel controller 254 may communicate with the EaaS manager 110 via the EaaS interface 242, which is configured to interact with the node APIs 113 surfaced by the EaaS manager 110. The node APIs 113 provide methods for accessing data relevant to the node 140 and the MESU(s) 150 associated with the node 140, and executing various functionality, such as signaling unavailability / availability for banking power, requesting a functional upgrade, such as a higher spin rate for one or more flywheels 152 or deactivating / activating a previously active / inactive flywheel 152, reporting usage data and/or state information, and so forth.

The flywheel Manager 244 of the node application is configured to communicate with the flywheel controller 254 to provide operational control signals, such as power banking signals, power extraction signals, spin rate adjustment signals, flywheel enablement/disablement signals, and so forth. The energy manager 246 is configured to communicate with the flywheel Manager 244 and provides controls signals to the flywheel manager depending on the energy requirements (produce energy for local use, produce energy for utility use, bank local energy, bank utility-provided energy, etc.).

The flywheel coupler 255 is configured to control the mechanical coupling of the flywheels 152 with the motor-generator, the flywheel selector 256 is configured to select which flywheels 152 to control based on the received control signals, and the flywheel monitor 257 monitors the state of each flywheel 152 for safe operation and performance within defined operational parameters, and can take control of the functionality of the MESU hardware 258 and shut down, slow, suspend, adjust, optimize, or other control the MESU hardware 258 depending on the monitored state.

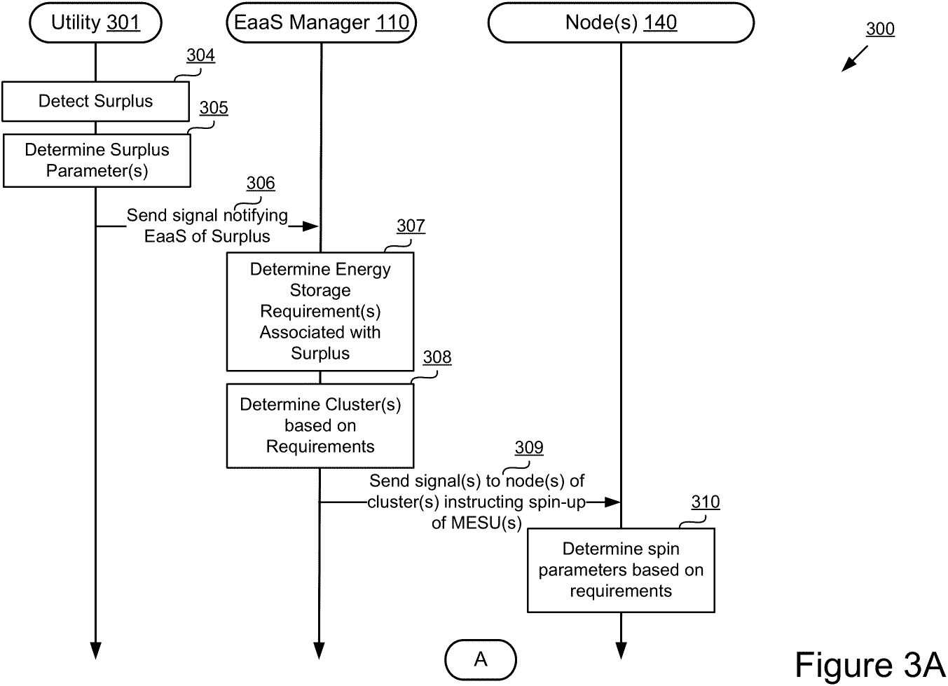

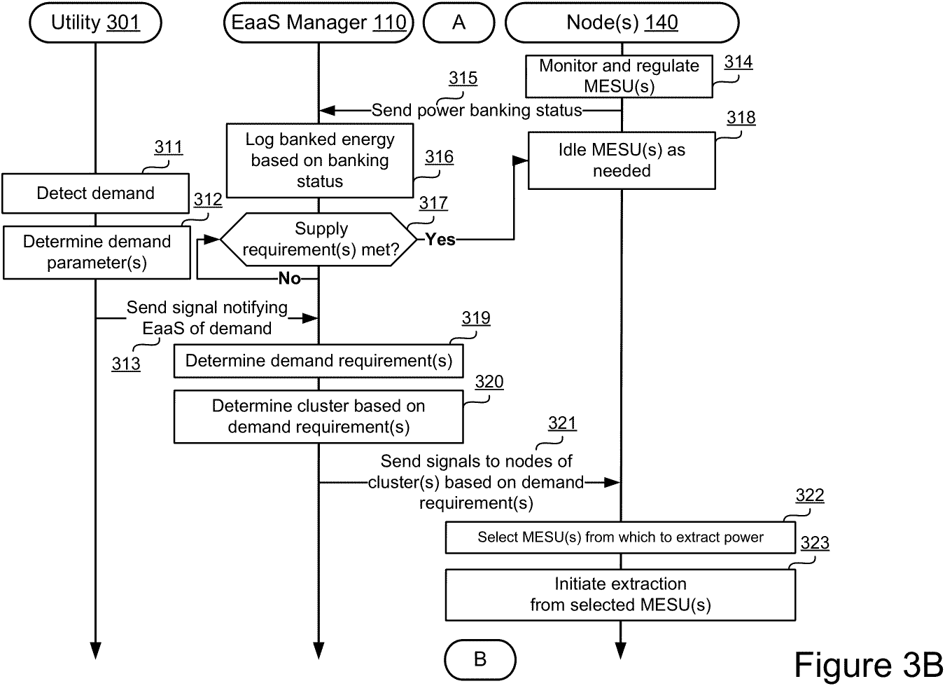

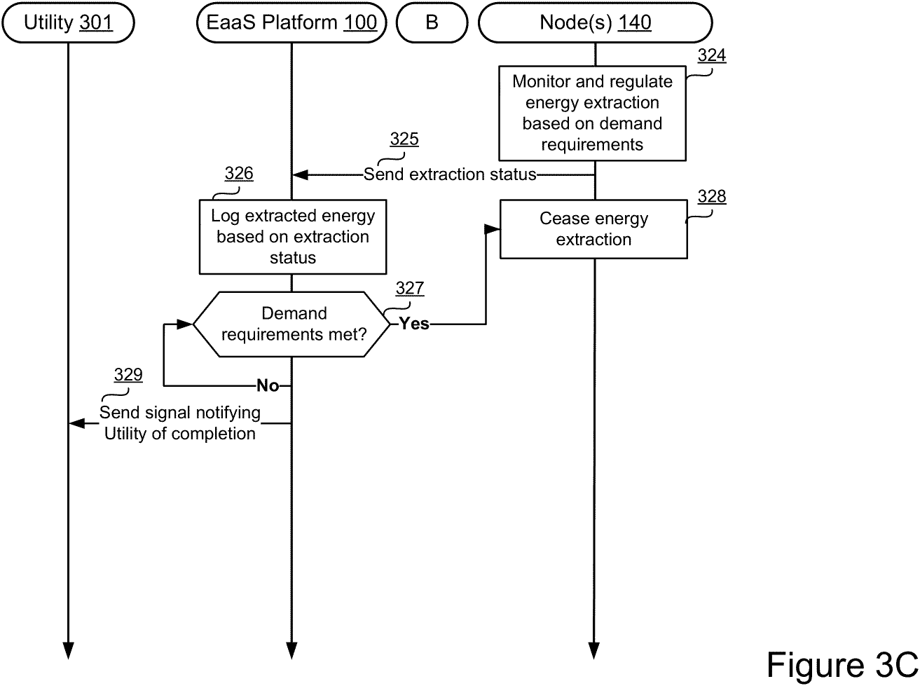

FIGS. 3A-3C depicted a signal diagram 300 illustrating an example method for banking and extracting energy for a utility 301 to satisfy a power need.

As shown in FIG. 3A, the utility management application 122 detects 304 a power surplus and determines 305 surplus parameter(s) in block 305. The utility management application 122 generates and sends a signal 306 notifying the EaaS manager 110 of the surplus. The EaaS manager 110 determines 307 energy storage requirement(s) associated with the surplus based on the signal and determines at block 308 one or more storage cluster(s) 160 based on the requirements. The EaaS manager 110 generates and sends at block 309 signals to the node(s) 140 of the Cluster(s) 160 (as reflected in the cluster data) instructing spin-up of the MESU(s) 150 of the cluster(s).

The nodes 140 (e.g., via their node application 240) determine 310 spin parameter(s) based on the requirement(s) and monitor and regulate 314 the MESU(s) 150 via the flywheel controller. The MESU(s) 150 of the node(s) 140 send 315 power banking statuses to the EaaS manager 110, which logs 316 the banked energy based on the banking status(es). The EaaS manager 110 monitors 317 whether the supply requirements have been met, and once they have been, signals the node(s) via their node applications 240 to idle the MESU(s) 150 as needed. In response, the MESU(s) 150 may be idled 318 as needed (e.g., by the node applications 240). In some embodiments, the MESU(s) 150 may be stepped down sequentially to ramp down the banked energy. In these or other embodiments, some or all MESU(s) 150 may be idled in parallel. Other variations are also possible and contemplated.

The EaaS manager 110 and/or the utility management application 122 may detect a power demand 311 and determine the parameter(s) 312 associated with the power demand. In some embodiments, the storage cluster (e.g., via the utility management application 122) generates and sends 313 a signal notifying the EaaS manager 110 of the demand, and responsive thereto, the EaaS manager 110 determines the demand requirement(s) 319 based on the signal and determines 320 the storage cluster(s) 160 based on the demand requirement(s). Next, the EaaS manager 110 generates and sends 321 signal(s) to the nodes 140 of the storage cluster(s) 160 based on the demand requirement(s). The node(s) (e.g., via the node application(s) 240) select 322 the MESU(s) 150 from which to extract power and initiate 323 power extraction from the selected MESU(s) 150.

It should be noted that the node 140 and the MESU 150 may be separate devices, components of a single device, separate devices, or otherwise. For instance, the operations and features of the node 140 and the MESU 150 may be combined, exchanged, or otherwise modified without departing from the scope of this disclosure.

As shown in FIG. 3C, the node(s) 140 (e.g., via the node applications 240) monitor and regulate 324 the energy extraction based on the demand requirement(s) and send 325 the extraction status(es) to the EaaS manager 110, which logs 326 the extracted energy in the data store 210 based on the extraction status. The EaaS manager 110 monitors 327, based on the statuses, if the demand requirements have been met. If so, the EaaS manager 110 signals the storage cluster(s) 160 of node(s) 140 to cease energy extraction, and the node(s) 140 (e.g., via their node applications 240) correspondingly cease 328 the extraction of power from the MESUs. The EaaS manager 110 then generates and sends 329 a signal notifying the storage cluster (e.g., via the utility management application 122) of the completion of the extraction.

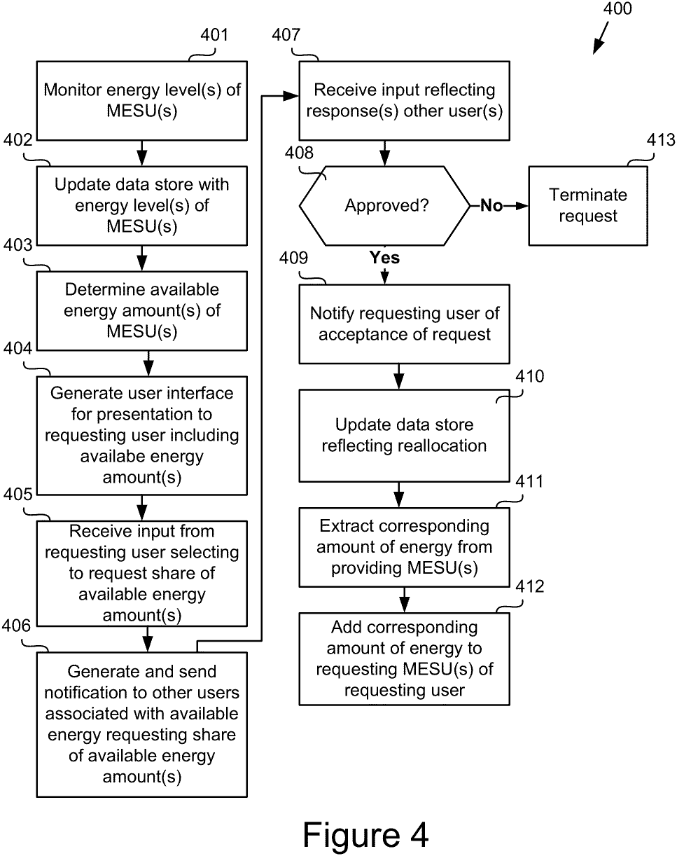

FIG. 4 is a flowchart illustrating an example method 400 for peer-to-peer power sharing. In block 401, the energy manager 246 of a given node 140 monitors the power levels of the MESU(s) 150 of that node 140 and, in block 402, signals the power management application 111 via the node APIs 113 to update the data store 210 with the power level(s) of the MESU(s) 150. In some embodiments, the flywheel monitor 257 monitors the operational status of the flywheels 152, including their spin rate, and communicates a power level for each flywheel 152 based on the operational status to the energy manager 246. In further embodiments, the flywheel monitor 257 stores data reflecting the operational status in a local non-transitory memory of the MESU 150 for retrieval by the energy manager 246 (e.g., on an ongoing basis). Other variations are also possible and contemplated.

In some embodiments, the energy manager 246 sends data to the node APIs 113 Via the EaaS interface 242 over the network 102 informing the power management application 111 of the current power levels of the MESU(s) 150, and the power management application 111, updates the user data 213 and/or node data 212 associated with the user and applicable MESU(s) 150 to reflect the current power level(s). Additionally or alternatively, the node(s) 140 may store the updated power level(s) locally in a non-transitory storage device of the node 140 or the MESU(s) 150, and may provision that data to the power management application 111 upon request. Other variations are also possible and contemplated, such as the user application 170 connecting directly to the node(s) 140 or MESU(s) 150 to receive the current power level(s).

In block 403, the power management application 111 may determine the available power amounts of the MESU(s) 150 from which power may be available to a requesting user. This may be performed in response to a request for available power that can be accessed. For example, a requesting user may have the need for additional power (e.g., the stored power levels of the MESU(s) 150 of the requesting user may be low) and may access a digital power marketplace interface served by the EaaS manager 110 (e.g., a server hosting a digital service embodied by the power management application 111, storage cluster APIs 112, node APIs 113, etc.) and request available power from the MESU(s) 150 of the other users of the service. In some embodiments, a user may set auto replenish settings to replenish certain flywheels if their effective power levels get too low, etc.). Numerous other variations are also possible and contemplated, as discussed elsewhere herein.

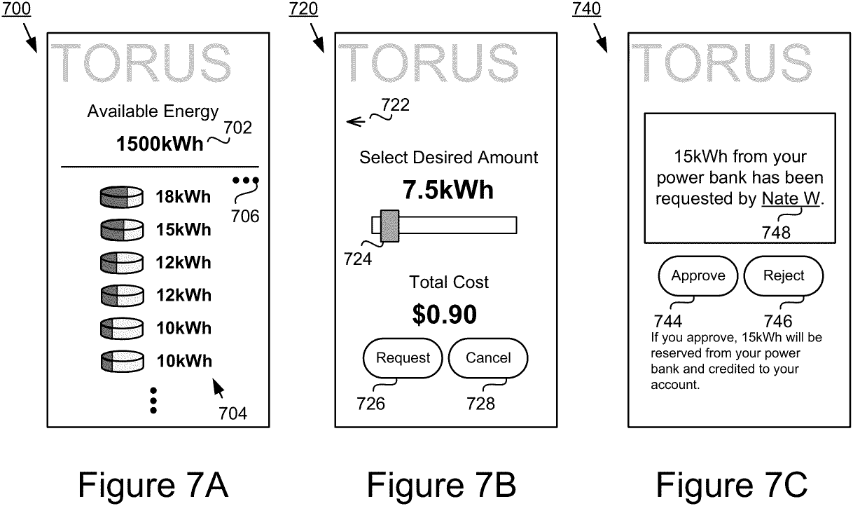

In block 404, the user application 170 associated with the power management application 111, which in some embodiments may comprise an instance of the power management application 111, may comprise an application that interfaces with the APIs of the EAS manager 110, or may take some other suitable form, may generate a user interface for presentation to the requesting user. The user interface may include user interface elements that reflect an available amount of power that the requesting user may request from the EaaS platform 100. In FIG. 7A, the graphical representation of the user interface 700 depicts a non-limiting example of such an interface. As shown, the user interface 700 include a summary region 704 indicating the total amount of power that it’s available to the user, and may further include a detail region listing the constituent MESU(s) 150 and the respective amounts of power they have available (other information may also be included such as cost per kWh, identifiers for the storage cluster 160, user 170, node 140, MESU(s) 150, etc.). The user interface 700 may further include options (e.g., selected at element 706) for sorting and filtering the constituent MESU(s) 150 including by cost (per kWh), location, or other suitable parameters.

Referring again to FIG. 4, in block 405, the user application 170 may receive an input from the requesting user via an input device of the computing device which the user application 170 is running. The input may comprise a user selection to request a share of the available power amount(s). For example, the requesting user may select a portion of the total available amount from all Storage Clusters 160, a group of Storage Clusters 160, a specific Storage Cluster 160, a Node or group of Nodes 140, a MESU 150 or group of MESU(s) 150, any combination of the foregoing, etc. For instance, depending on availability, the requesting user may select a portion or all of the available power from one or more specific MESU(s) 150 belonging to a specific user or any available MESU(s) 150 belong to any user, or some other combination.

As a further example, as shown in FIGS. 7A and 7B, responsive to a user selection of interface element 702 or one of the items interface element 704, the user application 170 may generate for presentation user interface 720 with which a user may interact via an input device to configure, submit or cancel a power request. In the depicted example, the interface 720 may a user-selectable interface element 722 for returning to the user interface 700, a user-selectable interface element 724, such as a slider or other incremental interface element for variably selecting a specific power amount, and user-selectable interface elements 726 and 728. For instance, the user positioned the user interface element 724 to an amount of 7.5 kilowatt hours (kWh), at a cost of $0.90, and may select the request button 726 to finalize the request for that amount of power or may cancel out of the request form and return back to interface 700 by selecting the cancel button 728.

Referring again to FIG. 4, responsive to receiving the input in block 405, the power management application 111 may generate and send a notification to the one or more users from which power is being requested. In some embodiments, the requesting user may request a specific amount of power from the first user. In further embodiments, the requesting user may request an amount of power from an energy pool comprised of a plurality of users. In such embodiments, the requesting user may not know the identities of the users from which power was requested. In such cases, the power management application 111 and notify those users of the request in advance or may simply proceed with the request based on prior authorization being provided by those users to share the power they have stored in their respective MSU’s with other users upon request, in which case the power management application 111 may passively provide notice that the power was shared with the requesting user. Other variations are also contemplated and encompassed hereby.

While FIG. 7C depicts an example notice interface 740 embodying an affirmative notice requiring approval, which comprises a message region 748 notifying the user of the share request and including a link 748 to a profile of the requesting user, and user-selectable options 744 and 746 for approving or rejecting the request (e.g., buttons 744 and 746), notices sent by the power management application 111 may comprise other forms and content, may be combined with other information may not require express consent, and may be provided in different contexts and through a variety of channels including push notifications, text messages, in application messages, via management dashboards, via popup windows, via electronic communications such as e-mail, etc.

It should be understood that in further embodiments, a user may set a standing request to obtain power from other users by setting certain parameters in an account management interface. In such a case, the user would not need to interact with the user interface to request power but may establish the requisite parameter(s) that, once satisfied, would trigger such a request, thereby creating a seamless experience for the user.

For example, the user may specify that when power from the power grid 130 costs more than power from the energy pool comprised of the available MESU(s) 150 (also simply referred to the MESU pool) of the EaaS Platform, that one or more MESU(s) 150 or flywheels from those MESU(s) 150 belonging to the user be charged (e.g. spun up and/or kept at a certain spin rate) using power from other MESU(s) 150. In another example, the user may specify that, at certain times during the day, such as when local production by the user’s independent power system 147 (e.g., solar electric system 144 installed on the user’s house) is low, power available from the MESU pool be used to charge / maintain all or certain of the user’s MESU(s) 150 or flywheels 152 thereof. This example can be further augmented to factor in the cost of power from the Power Grid 130 as in the previous example. Using the power management application 111, the user can advantageously set parameters on a flywheel-by-flywheel basis to optimize the user’s preference and experience. Numerous other variations are also possible and contemplated.

Referring again to FIG. 4, in block 407, the power management application 111 may receipt input (e.g., via a user application 170) reflecting a response from users from which power was requested by the requesting user (e.g., the first user), and if approved may proceed with the request as shown in block 408 or terminate the request as shown in block 413. In embodiments where a request was sent to a plurality of users drawn from the MESU pool, if any such users rejected the request, the power management application 111 may select alternative users from the available pool of MESU(s) 150 and may generate and send notices to them. This way the request may go through even though some of the users rejected the share request.

In further embodiments where users forming the MESU pool have affirmatively opted in to sharing power without notice, the operations in blocks 406, 407, 408, and 413 may be omitted or skipped by the power management application 111 (resulting in the auto-approval of the request). Other variations may include a hybrid where some users associated with the share request receive express notifications (requiring approval) while others (due to their prior consent) do not require it. This advantageously facilitates a faster power sharing experience between users.

In block 409, responsive to determining the request was approved (e.g., automatically or based on affirmative responses), the power management application 111 may notify the requesting user of the acceptance of the request (e.g., via a user application 170).

In blocks 410, 411, and 412, the power management application 111, in cooperation with instances of the node application 240, redistribute power between the MESU(s) 150 of the requesting user and the users from which power is to be provided. Depending on the configuration of the power infrastructure that is connected to the MESU(s) 150 of the requesting user, this may be effectuated in a variety of ways. In some embodiments, these MESU(s) 150 may be electrically connected directly to other storage clusters 160 or nodes 140 and power may thus be transferred without using the Power Grid 130. This may advantageously result in a more power and cost-efficient approach since a direct transfer approach is more energy efficient than transferring power to/from the Power Grid 130 and power does not need to be bought from/sold to or de-credited from/credited to a utility 301 (and thus a lower conversion rate and fees or no conversion rate and fees may apply).

In further embodiments, power may be transferred via the power grid 130 from the providing MESU(s) 150 at times of the day that is the most cost-efficient or from regions that are the most power-efficient to the requesting MESU(s) 150 to ensure the lowest cost is being incurred from the transfer. In still further embodiments, power may be banked to the power grid 130 from the providing MESU(s) 150 at an optimal time based on their applicable power costs/credits and then extracted from the power grid 130 to the receiving MESU(s) 150 at a later optimal time based on power costs/credits that apply to the receiving MESU(s) 150. It should be understood that numerous further variations are also possible and contemplated.

For any of these embodiments, in block 410, the power management application 111 updates the data store 210 to reallocate the share of available power amounts(s). In some embodiments, the power management application 111 may update the user data 213 of the user of the MESU pool and the requesting user to reflect the amount of power that should be transferred from one or more MESU(s) 150 (the providing MESU(s)) 150) of the providing user(s) to one or more MESU(s) 150 (the requesting MESU(s) 150) of the requesting user. In embodiments involving a plurality of users providing a portion of the power requested by the requesting user, the power management application 111 updates the user data 213 of those users to reflect the factional amounts of power that should be transferred from their respective MESU(s) 150.

When reallocating power in blocks 410, 411, and 412, and additionally or alternatively when indicating available power for block 404, the power management application 111 may reconcile the amount of power requested with flywheel restrictions and threshold limitations so that power is provided by sanctioned/approved/enabled flywheels and minimum flywheel spin rates are maintained as specified by the sharing users, as reflected in the node data 212 associated with the MESU(s) 150 and flywheels 152, as discussed further elsewhere herein. The power management application 111 further reference spending limits and costs considerations to determine the power that may be available to a given user from the EaaS platform 100.

In block 411, based on the updated settings in block 410, the power management application 111 signals the energy manager 246 of the node application 240 via the EaaS Interface 242 of the providing MESU(s) 150 to extract power from one or more flywheels 152 of the MESU(s) 150 (depending on their settings and configuration), and in block 412, instructs the energy manager 246 of the node application 240 via the EaaS Interface 242 of the receiving MESU(s) 150 to add a corresponding amount of energy by spinning up one of more flywheels of the MESU(s) 150 (depending on their settings and configuration). The stored user data 212 may indicate the specific MESU(s) 150 from which power should be transferred, specific flywheels of specific MESU(s) 150 from which power should be transferred, and so forth.

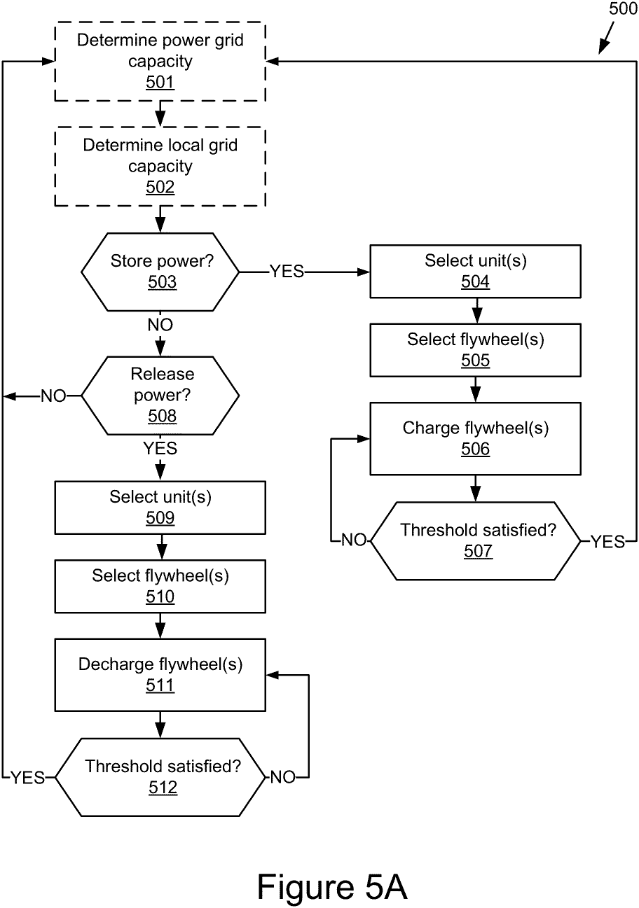

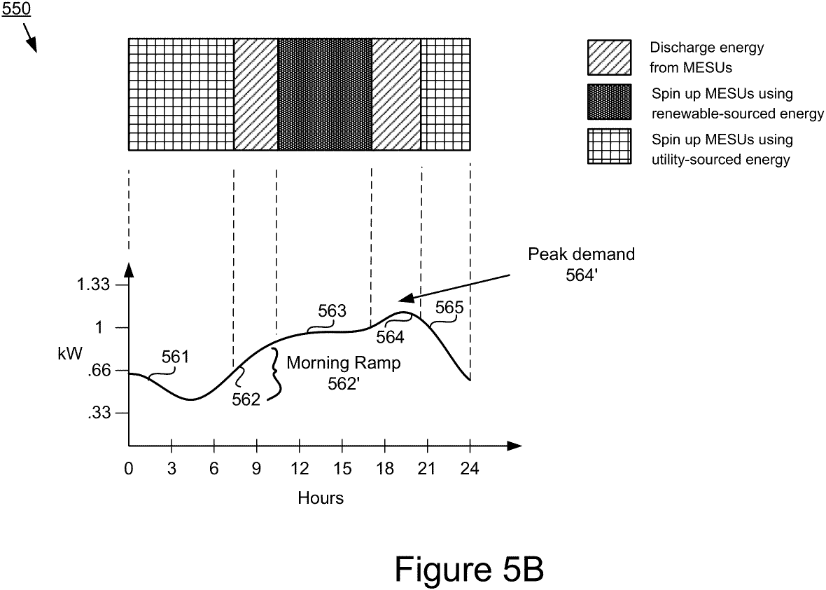

FIG. 5A is a flowchart illustrating an example method 500 for providing a cyclical storage and release solution based on power demand, production, and/or other factors. It should be noted that the operations of the example method 500 may include additional or fewer components, different sequencing, and/or be combined or exchanged with other operations and features described herein. For example, operations or parameters of the method 500 may be based on user settings, such as a selection to store power, a target cycle frequency, a target charge or discharge amount, or other settings, as described below. In some embodiments, operations or parameters of the method 500 may additionally or alternatively be based on other factors such as local or utility power needs. For example, the operations or parameters may be modified statically or dynamically based on power needs of a grid, local power-consuming device, etc., based on times that are cost-efficient (e.g., where time of use or other considerations are present).

It should also be noted that although the operations of the method 500 are illustrative as being iterative and recursive, they may be performed at any frequency, continuously, and/or concurrently across multiple systems, grids, or storage units, etc.

The operations of the method 500 are described as being performed or controlled by the energy manager 246; although, it should be noted that other embodiments are possible and contemplated herein. For instance, the energy manager 246 may receive communication(s) from a power management application 111, as described elsewhere herein, which may include grid information, instructions or requests to store power, instructions or requests to provide power to the grid, or other information. In some instances, the instructions of the power management application 111 may be subject to constraints defined for a node 140 or other storage unit. For instance, an administrator or other stakeholder may define a setting to limit the amount or percentage of power charged or discharged as a static or dynamic quantity, although other settings, constraints, or preferences are possible.

In some embodiments, at block 501, the energy manager 246 may determine a power grid capacity. For example, an industrial power grid (e.g., provided by a utility service) may have excess or negative power capacity that may be received or filled by a node 140 and/or independent power system 147. The energy manager 246 may communicate with the power management application 111, utility management application 122, or systems, for example using an EaaS interface 242 and/or node APIs 113 to determine a power production, capacity, or draw on the power grid. In some instances, the energy manager 246 may determine a negative or positive capacity based on a predicted demand, for example, based on a time period, predicted capacity, whether, or other defined data as illustrated in the example duck curve of FIG. 5B.

For example, as illustrated and described below in reference to FIG. 5B, a power grid may experience varying production (e.g., based on solar production) and/or demand over time. In order to smooth time periods of peak demand (e.g., as indicated at 564′) or low demand, the utility management application 122 or power management application 111 may indicate positive or negative capacity that may be offloaded or requested to or from energy storage units based on whether the current production or demand of the power grid is above/below an average or desired level.

Returning to FIG. 5A, in some embodiments, at block 502, the energy manager 246 may determine a local grid capacity, for example, of an independent power system 147. For example, the energy manager 246 may determine whether the independent power system (e.g., using the solar electric system 144, wind turbine system 146, and/or other power sources 148) has a positive or negative flow rate into or out of the grid, or otherwise a quantity of power needed to be added or removed to balance the system or otherwise reach a target storage or production rate.

For example, as a local grid produces excess power (e.g., by a solar electric system 144), the determine that this excess capacity should be offloaded to a power grid to address a duck curve, stored in a node 140 to address the duck curve or bank power, or based on other factors such as time-of-use rates, desired backup power storage, or otherwise.

In some embodiments, in addition to or alternative from the current production or demand, at blocks 501 or 502, the method 500 may determine a target capacity, inflow or outflow rate, or otherwise to set thresholds for using, storing, or providing power to the power grid or local grid. These values may further be modified based on the total possible storage capacity of the power grid, local grid, node(s), defined transfer rate, etc., as described elsewhere herein.

At block 503, the energy manager 246 may determine whether and/or how much power to store, for example, based on whether the power grid is requesting to offload or receive capacity, a local power demand or production of the local grid, and an available storage capacity of the node(s) 140. For example, if solar power production in the afternoon is causing both the power grid and local grid to have excess capacity (e.g., exceeding a demand), the energy manager 246 may determine to store power at the storage unit(s). Similarly, if the local grid and/or power grid have low capacity or production (e.g., a need for power at high demand or low production), the energy manager 246 may determine to release power (as noted below).

Responsive to a determination at block 503 to store power, the energy manager 246 may select one or more storage units or nodes 140, which may include MESU(s) 150 or flywheels 152 described herein, to which to store power at block 504. The energy manager 246 and/or power management application 111 may select one or more from a plurality of storage units, such as nodes, flywheels, etc., to which to store power based on available energy storage capacity of those storage units, balancing of nodes 140, sequential usage of nodes 140, power cycling frequencies or requirements, or otherwise. For instance, the block 503 may include determining which node has sufficient available storage capacity to receive the power.

In some instances, at block 505, the energy manager 246 may select one or more flywheels of the energy storage units or nodes 140 to receive the power. The flywheel(s) may be selected based on their available storage capacity, a safe or optimal capacity or rotational frequency, balancing wear, or other configurations. In some embodiments, an energy manager 246 may sequentially charge or balance the charges.

At block 506, the energy manager 246 may charge the selected one or more flywheels using the power for storage (e.g., as determined at blocks 501 or 502). For instance, the energy manager 246 may control distribution of the power to the selected flywheels to spin them up (e.g., via interaction with a flywheel manager 244).

At block 507, the energy manager 246 may determine whether a defined threshold has been satisfied. The defined threshold may be based on the power amount to be stored or an available capacity of energy storage units. For instance, a flywheel may have a hardware or software constrained maximum or minimum storage capacity threshold.

If the determination at block 507 is that the threshold is satisfied, the method 500 may return to block 501. If the determination at block 507 is negative, the method 500 may continue at blocks 504, 505, or 506 to store the remaining power based on available capacity or characteristics of the storage units, flywheels, etc., as noted above.

Returning to the operation at block 503, if the determination to store power is negative, the method 500 may proceed to block 508 at which the energy manager 246 may determine whether to release power, for example, into a grid from an power storage device, such as a node 140. As noted in reference to block 503, the energy manager 246 may determine to release power based on whether the power grid and/or local grid are requesting power. The determination of whether to release power may additionally or alternatively be based on a target energy storage value or range defined or determined for the storage unit(s). For instance, the energy manager 246 may determine an amount of power to release from the storage unit(s) based on how much power is being requested by the grid(s), how much excess power (e.g., above a threshold minimum storage, efficient storage, or otherwise available storage) is stored by the storage unit, and/or a threshold minimum or preferred power storage defined by a stakeholder setting.

In some instances, a storage unit may have no excess storage beyond a hardware or software constrained minimum threshold (e.g., based on preference settings, physical configuration, etc.), so the determination at 508 may be negative and the method 500 may return to block 501 or 502, for example.

Responsive to a positive determination at block 508, the energy manager 246 may release power into the power grid or utility grid. For instance, the energy manager 246, power management application 111, utility management application 122, or otherwise may perform blocks 509-512, which may be parallel with blocks 504-507, to release power from storage unit(s).

For example, at block 509, the energy manager 246 may select one or more energy storage units (e.g., node(s) 140) having available energy storage. At block 510, the energy manager 246 may select one or more flywheels associated with the energy storage unit(s) to discharge, for example, based on their available storage, power delivery characteristics (e.g., how quickly they can supply power, a maximum available current, a current rotational frequency, etc.), or other factors. At block 511, the energy manager 246 may instruct (e.g., via interaction with a flywheel manager 244) the one or more flywheels 511 to discharge and provide their power to the grid(s).

At block 512, the energy manager 246 determine whether a threshold discharge amount has been satisfied. Similar to the determination at 507, the threshold may be based on a requested amount of power for a grid capacity and/or an available amount of power stored in the energy storage unit(s) (e.g., based on a total available power or a defined available range). If the threshold at block 512 has not been satisfied, the energy manager 246 may continue to discharge the flywheel(s) until the threshold is satisfied. If the threshold has been satisfied or cannot be satisfied (e.g., due to no remaining available power being stored), the method may return to blocks 501 or 502.

Accordingly, using the operations of example method 500, the technology may automatically fill energy storage using locally or remotely produced power during periods of low demand, as illustrated in the example of FIG. 5B. Similarly, during periods of high demand, the method 500 may discharge energy storage into the grid(s). Thus, the power production and demand may be smoothed, thereby improving efficiency of the power grid and/or local grid, as noted elsewhere herein.

FIG. 5B depicts a graph 550 illustrating an example power cycle for a given day of the week for a premises 142, such as a residential home. As shown, between midnight and 7:30 am (561), local solar power production is low, so the node application uses power from the grid to spin up or maintain the spin rate of the flywheel(s) 152 of a MESU(s) 150. Between 7:30 AM and 11 AM (562), power demand surges (reflecting a morning ramp up 562′), so the node application 240 discharges power from the flywheel(s) 152 of the MESU(s) 150 to meet power requirements of the premises 142 and/or provide power to the power grid 130 (if so configured / needed). From 11 AM to 5 PM (17:00) (563), demand is relatively flat but local solar power production is strong, so the node application 240 spins up the flywheel(s) 152 of the MESU(s) 150 using renewable-sourced power. From 5PM (17:00) to 8:30 PM (20:30) (564), power demand is peaking, so the node application 240 again extracts power from the flywheel(s) 152 of the MESU(s) 150 to meet the demand. From 8:30 PM (20:30) to midnight (24:00) (565), demand wains and the node application 240 again spins up the flywheel(s) 152 of the MESU(s) 150 using utility-sourced power.

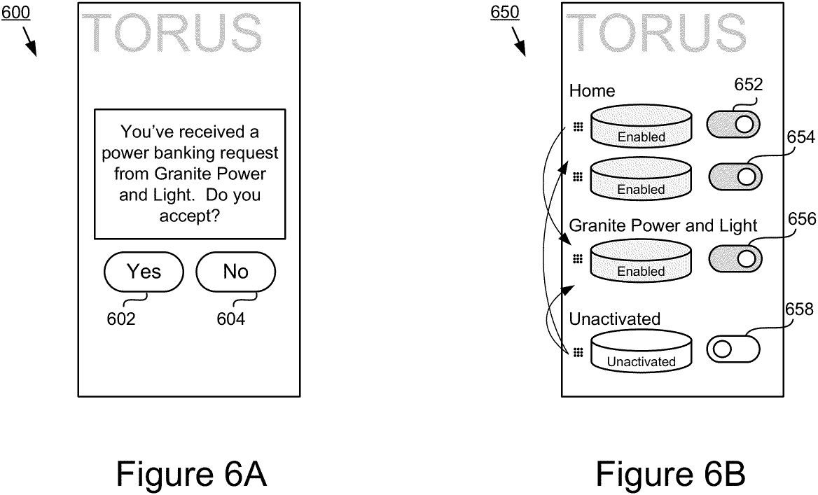

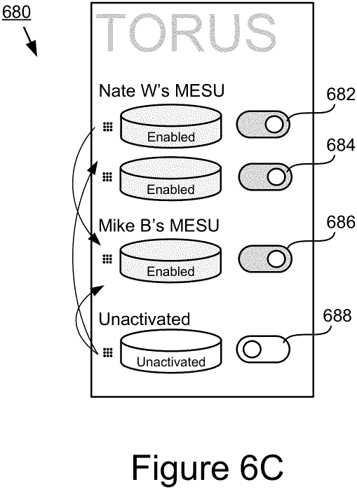

FIGS. 6A and 6B depict example user interfaces 600 and 650 for configuring the MESU(s) 150 associated with a node 140 and/or storage cluster 160. As shown in FIG. 5A, a user may receive a power banking request from a storage cluster requesting permission to bank power using one or more flywheels 152 of the of the user’s MESU(s) 150. The user may accept or deny the request by providing input via an input device (e.g., touchscreen) of the user’s computing device selecting the corresponding graphical element displayed in the interface (e.g., Yes 602 or No 604 button).

In FIG. 6B, a user may configure preferences on a flywheel-by-flywheel basis. For example, the user may drag a flywheel 152 from Home to Granite Power and Light, which would enable Granite Power and Light to bank power to that flywheel 152, or vice versa. The user may also enable or disable flywheels 152 to activate or inactivate them, as well as view analytics about each flywheel 152 by selecting one, which presents an interface showing usage, performance and other analytics about the flywheel 152, along with cost savings, expenditures, and so forth. For example, interaction elements 652, 654, 656, and 658 are illustrated as toggle switches allowing flywheels to be activated or inactivated.

As shown in the example user interface 680 depicted in FIG. 6C, a user may allocate a flywheel 152 to another user for that user to bank power (Nate W may allocate a flywheel 152 for Mike B’s use, or vice versa) by dragging the flywheel 152 via the interface to the corresponding location. Additionally, flywheels 152 may be drilled down into or enabled or disabled, as further shown. It should be understood that in some embodiments, parameters of a given flywheel 152 may be set via the interface, such as the permitted spin rate. For example, the capacity of the flywheel 152, as determined by the spin rate, may be locked at different levels by the EaaS platform, and the user may upgrade a flywheel 152 by “upping” the spin rate to a higher level (increase the energy storage capacity of the flywheel 152). For example, the max spin rate may be set to 10,000 RPM, and the user may select to upgrade the spin rate to 15,000 RPM, for an additional 30% storage capacity. Responsive to selecting this option in the corresponding user interface, the node application may generate and send a request to the EaaS manager 110 requesting authorization for the upgrade. The EaaS manager 110 may update the user’s account reflecting the upgrade and may increase the user’s subscription plan to reflect the upgrade (charge the user’s account additionally for the extra capacity). Responsive to upgrading the user’s account, the EaaS manager 110 may signal the node application that the upgrade was successful, and the node application may store configuration data locally reflecting the change and signal the flywheel controller 254 to spin one or more flywheels 152 up to 15,000 RPM. As noted in the examples above, graphical elements 682, 684, 686, and 688 may be provided for the flywheels to enable or disable them.

It should be understood that the technology and implementations described herein are provided by way of example, and that variations and combinations of the implementations are contemplated. For example, in some implementations, at least a portion of one or more of the methods represent various segments of one or more larger methods and may be concatenated or various steps of these methods may be combined to produce other methods which are encompassed by the present disclosure. Additionally, it should be understood that various operations in the methods may in some cases be iterative, and thus repeated as many times as necessary generate the results described herein. Further the ordering of the operations in the methods is provided by way of example and it should be understood that various operations may occur earlier and/or later in the method without departing from the scope thereof.

Further, while some specific details are set forth in order to provide a thorough understanding of the present disclosure, it should be understood that the technology described herein may be practiced without these specific details. In some cases, various systems, devices, and structures are shown in block diagram form in order to avoid obscuring the description. For instance, various embodiments are described as having particular hardware, software, and/or user interfaces. However, the present disclosure applies to any suitable variation that is capable of providing the described structure and/or functionality.

Thus, the specification may be embodied in other specific forms without departing from the spirit or essential characteristics thereof. Likewise, the particular naming and division of the modules, routines, features, attributes, methodologies, and other aspects may not be mandatory or significant, and the mechanisms that implement the specification or its features may have different names, divisions and/or formats.

Unless specifically stated otherwise as apparent from the following discussion, it is appreciated that throughout this disclosure, discussions utilizing terms such as “processing,” “computing,” “calculating,” “determining,” “displaying,” “communicating,” “transmitting,” or the like, may refer to the action and methods of a computer system that manipulates and transforms data represented as physical (electronic) quantities within the computer system’s registers and memories into other data similarly represented as physical quantities within the computer system memories or registers or other such information storage, transmission or display devices.

A computing system or device (e.g., data processing system) suitable for storing and/or executing program code, such as the computing systems and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices can be coupled to the system either directly or through intervening I/O controllers. A data processing system may include an apparatus may be specially constructed for the required purposes, or it may comprise a general-purpose computer selectively activated or reconfigured by a computer program stored in the computer.

Additionally, the modules, routines, features, attributes, methodologies, and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to embodiment in any specific programming language, or for any specific operating system or environment. Accordingly, the disclosure is intended to be illustrative, but not limiting, of the scope of the subject matter set forth in the following claims.

What is claimed is:

1. A system comprising:
a first node having a first mechanical energy storage unit (MESU) located in a first geographical location, the first node being coupled for communication with an energy as a service (EaaS) platform; and
a second node having a second MESU located in a second geographical location that is distinct from the first geographical location, the second node being coupled for communication with the EaaS platform, wherein the first MESU of the first node and the second MESU of the second node are each configured to send a power banking status to the EaaS platform and to extract or bank power based on signals received from the EaaS platform.

2. The system of claim 1, wherein each of the first MESU and the second MESU include a motor coupled to one or more flywheels that is capable of increasing or decreasing a spin-rate of the one or more flywheels to add to or extract power from the one or more flywheels, respectively.

3. The system of claim 2, wherein each of the first MESU and the second MESU are capable of storing between 3 kWh and 100 kWh of power.

4. The system of claim 1, further comprising:
the Energy as a Service (EaaS) platform including:
a power management application coupled to the first MESU of the first node and the second MESU of the second node via a communications network; and
one or more node application programming interfaces (APIs) coupled to the power management application and configured to receive the power banking status and provide the power banking status to the power management application; and
one or more utility APIs coupled to the power management application and configured to receive one or more energy requests via a communications network from a utility server.

5. The system of claim 4, wherein the one or more utility APIs are further configured to receive a signal notifying the EaaS platform of an energy surplus or an energy demand.

6. The system of claim 5, wherein each of the first node and the second node includes an EaaS interface configured to receive a signal instructing a spin-up or a spin-down of the first MESU or the second MESU.

7. The system of claim 4, wherein:
the power management application is configured to:
receive a user setting specifying a spin rate for the first MESU;
store the user setting in a data store; and
transmit the user setting to the first node; and
the first MESU is configured to limit the spin rate for the first MESU based on the user setting.

8. The system of claim 4, wherein:
the power management application is configured to:
receive a user-specified power banking parameter for the first MESU;
store the user-specified power banking parameter in a data store in association with the first MESU; and
transmit a user-specified power banking parameter to the first node; and
the first MESU is configured to enable or disable the first MESU based on the user-specified power banking parameter.

9. The system of claim 1, wherein:
each of the first node and the second node comprises an energy manager configured to interact with an independent power system that provides off-grid power to one or more of the first node and the second node; and
each of the first MESU of the first node and the second MESU of the second node each includes MESU hardware electrically coupled to the independent power system, respectively.

10. The system of claim 9, the energy manager selectively determines whether to use power from the independent power system or a power grid based on one or more of a power capacity of the independent power system and a power capacity of the power grid.

11. A computer-implemented method comprising:
receiving, by one or more processors, a signal instructing a spin up of one or more mechanical energy storage units (MESU), each of the one or more MESUs including a mechanism for mechanically storing energy;
receiving, by the one or more processors, a power banking parameter for the one or more MESUs; and
enabling the one or more MESUs to receive power based on the power banking parameter and the signal instructing the spin up of the one or more MESUs.

12. The computer-implemented method of claim 11, wherein each of the one or more MESUs include a motor coupled to one or more flywheels that is capable of increasing or decreasing a spin-rate of the one or more flywheels to add to or extract power from the one or more flywheels, respectively.

13. The computer-implemented method of claim 11, further comprising generating, by the one or more processors, a signal instructing the spin up or a spin down of the one or more MESUs based on a determined energy surplus or demand.

14. The computer-implemented method of claim 11, further comprising:
receiving, by the one or more processors, a user setting specifying a spin rate for the one or more MESUs;
storing, by the one or more processors, the user setting in a data store; and
configuring, by the one or more processors, the one or more MESUs to limit the spin rate based on the user setting in the data store.

15. The computer-implemented method of claim 11, wherein:
the one or more MESUs are coupled with one or more nodes, the one or more nodes including an energy manager configured to interact with an independent power system that provides off-grid power to the one or more MESUs; and
each of the one or more MESUs includes hardware electrically coupled to the independent power system.

16. The computer-implemented method of claim 15, further comprising:
determining, the one or more processors, to use power from the independent power system based on a power capacity of the independent power system; and
configuring, by the one or more processors, the one or more nodes to use power from the independent power system to spin up the one or more MESUs.

17. The computer-implemented method of claim 15, further comprising:
determining to use power from a power grid based on one or more of a power capacity of the independent power system and a power capacity of the power grid; and
configuring, by the one or more processors, the one or more nodes to use power from the power grid to spin up the one or more MESUs.

18. The computer-implemented method of claim 11, further comprising:
receiving, by the one or more processors, a signal instructing a spin-down of the one or more MESUs; and
instructing the one or more MESUs to spin down based on the power banking parameter and the signal instructing the spin down.

19. The computer-implemented method of claim 18, wherein:
the one or more MESUs receive electrical current responsive to the instruction to spin up; and
the one or more MESUs output electrical current responsive to the instruction to spin down.

20. The computer-implemented method of claim 18, wherein the signal instructing the spin up or the signal instructing the spin down of the one or more MESUs is based on one or more energy requests received via a communications network from a utility server.
